(19) United States
(12) Patent Application Publication
(10) Pub. No.: US 2025/0360867 A1
(43) Pub. Date: Nov. 27, 2025

(54) FRONT TURN LAMP, VEHICLE HEADLIGHT

(71) Applicant: STANLEY ELECTRIC CO., LTD., Tokyo (JP)

(72) Inventors: Wataru NAKASHIMA, Tokyo (JP); Takeshi WARAGAYA, Tokyo (JP); Kazuya WAKABAYASHI, Tokyo (JP)

(21) Appl. No.: 19/213,706

(22) Filed: May 20, 2025

(30) Foreign Application Priority Data
May 27, 2024 (JP) 2024-085574

(51) Int. Cl. B60Q 1/34

(52) U.S. Cl. CPC B60Q 1/34; B60Q 2900/50

(57) ABSTRACT

A front turn lamp arranged adjacent to each of a pair of headlights or integrally arranged with the pair of headlights at the front of a vehicle, characterized in that, as a light distribution pattern on a virtual screen of the front turn lamp, within a front turn light distribution standard range, a light emitted by the front turn lamp has a first luminous intensity peak near the center where a horizontal line intersects with a vertical line, and a second luminous intensity peak at an angle position away from the front of the vehicle to the side thereof.

The present application is based on, and claims priority benefit under 35 U.S.C. 119 from Japanese patent application No. 2024-085574, filed on May 27, 2024, the disclosure of which is hereby incorporated by reference herein in its entirety.

### BACKGROUND

### Technical Field

The present disclosure relates to a front turn lamp and a vehicle headlight.

### Description of the Background Art

The publication of Japanese Patent No. 5664900 (Patent Document 1) describes a vehicle optical unit configured to be able to form a light distribution for front turn lamps. In the light distribution for front turn lamps formed by this vehicle optical unit, the irradiation area with a luminous intensity exceeding 100 cd is within a range of approximately 20° above the horizon to 10° below the horizon in the vertical direction, and in a range of 23° on both the left and right sides in the horizontal direction based on the vertical direction. This irradiation typical for light distribution for front turn lamps.

However, in the above-described light distribution for front turn lamps, when using front turn lamps that turn on (flashes), from an own vehicle driver's point of view, it is difficult to recognize light emitted by the front turn lamps, and it is difficult to feel that the front turn lamp is turned on.

This can lead to the driver to forget to turn on and off the front turn lamps.

In a specific aspect, it is an object of the present disclosure to provide a technology that makes it easier for the driver to feel that the front turn lamp is turned on.

### SUMMARY

(1) A front turn lamp according to one aspect of the present disclosure is a front turn lamp arranged adjacent to each of a pair of headlights or integrally arranged with the pair of headlights at the front of a vehicle, characterized in that, as a light distribution pattern on a virtual screen of the front turn lamp, within a front turn light distribution standard range, a light emitted by the front turn lamp has a first luminous intensity peak near the center where a horizontal line intersects with a vertical line, and a second luminous intensity peak at an angle position away from the front of the vehicle to the side thereof.

(2) A front turn lamp according to one aspect of the present disclosure is a front turn lamp arranged adjacent to each of a pair of headlights or integrally arranged with the pair of headlights at the front of a vehicle, the front turn lamp including: a first front turn lamp that is arranged on a first side, which is one of the left and right sides of the vehicle and is not the side where a driver's seat is located, and is configured to be able to irradiate a first flashing light onto an area including a first range extending diagonally forward to the side of the first side; and a second front turn lamp that is arranged on a second side opposite the first side, and is configured to be able to irradiate a second flashing light onto an area including a second range extending diagonally forward to the side of the second side; where the first range is a range on a virtual screen of the first front turn lamp, and is set within a range of 80° to 30° on the first side based on an axis that is parallel to fore-and-aft direction of the vehicle and passes through a predetermined position of the first front turn lamp, where, in the first range, a continuous luminous intensity band of 100 cd or more is formed when the first flashing light is emitted by the first front turn lamp; where the second range is a range on a virtual screen of the second front turn lamp, and is set within a range of 80° to 30° on the second side based on an axis that is parallel to fore-and-aft direction of the vehicle and passes through a predetermined position of the second front turn lamp; and where, in the second range, a continuous luminous intensity band of 100 cd or more is formed when the second flashing light is emitted by the second front turn lamp.

(3) A vehicle headlight according to one aspect of the present disclosure is a vehicle headlight including: the front turn lamp according to the above-described (1) or (2); a controller connected to the front turn lamp; and a rainfall sensor connected to the controller, where the controller activates the front turn lamp when it is estimated that it is raining around the vehicle based on a detection result of the rainfall sensor.

(4) A vehicle headlight according to one aspect of the present disclosure is a vehicle headlight including: the front turn lamp according to the above-described (1) or (2); a controller connected to the front turn lamp; and an illuminance sensor connected to the controller, where the controller activates the front turn lamp when it is estimated that it is nighttime around the vehicle based on a detection result of the illuminance sensor.

According to the above configurations, a technology is provided that makes it easier for the driver to feel that the front turn lamp is turned on.

### BRIEF DESCRIPTION OF THE DRAWINGS

FIG. 1 is a block for explaining the configuration of a vehicle headlight according to the first embodiment.

FIG. 2 is a diagram for explaining the field of view of the driver of the own vehicle.

FIG. 3 is a diagram for explaining an example of an irradiation area of light emitted by the vehicle headlight of the present embodiment.

FIG. 4 is a diagram for explaining the range of flashing light Tb emitted from side irradiation lamp 13L of front turn lamp 11L.

FIG. 5 is a diagram for explaining an example of irradiation of flashing lights Ta, Tb by front turn lamp 11L.

FIG. 6 is a block diagram for explaining the configuration of a vehicle headlight according to the second embodiment.

### DESCRIPTION OF THE PREFERRED EMBODIMENTS

### First Embodiment

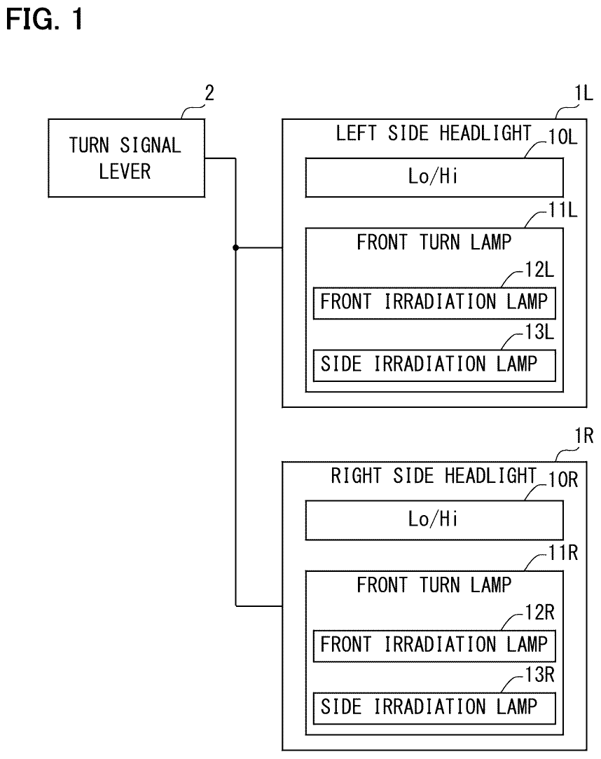

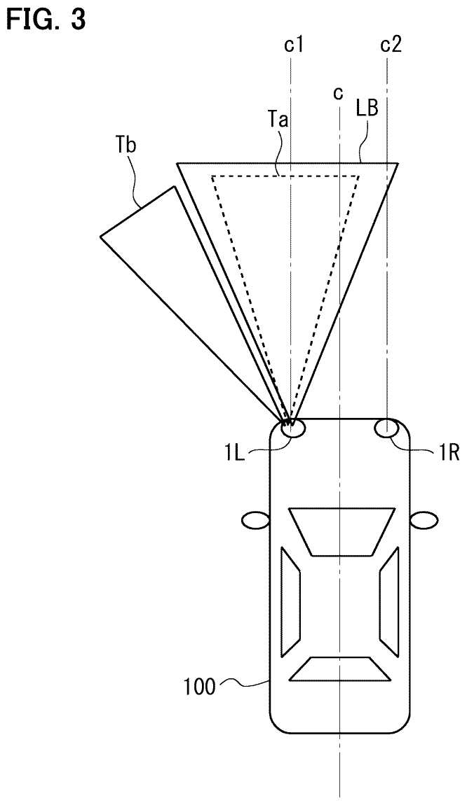

FIG. 1 is a block diagram for explaining the configuration of a vehicle headlight according to the first embodiment. The vehicle headlight of the first embodiment is configured to include a left side headlight 1L and a right side headlight 1R. As shown schematically in FIG. 3 which will be described below, left side headlight 1L is installed on the front left side of an own vehicle 100, and right side headlight 1R is installed on the front right side of the own vehicle.

Left side headlight 1L and right side headlight 1R are each connected to a turn signal lever 2 installed near the driver's seat of the own vehicle. Here, note that the term “connected” is not limited to a direct connection via wiring or the like, but also includes an indirect connection so as to receive a signal via a vehicle control device (not shown) or the like.

Left side headlight 1L is configured to include a lamp (Lo/Hi) 10L for emitting low and high beams in front of the own vehicle, and a front turn lamp 11L (first front turn lamp) that functions as a turn indicator. Front turn lamp 11L is configured with a built-in front irradiation lamp 12L and a side irradiation lamp 13L. Front turn lamp 11L mainly emits an amber-color flashing light as a turn indicator to the area in front of the left side of the own vehicle and the area diagonally forward to the left side of the own vehicle. Front irradiation lamp 12L emits a flashing light to the area in front (front forward) of the own vehicle. The side irradiation lamp 13L emits a flashing light to the area diagonally forward to the left side of the own vehicle.

Right side headlight 1R is configured to include a lamp (Lo/Hi) 10R for irradiating low and high beams in front of the own vehicle, and a front turn lamp 11R (second front turn lamp) that functions as a turn indicator. Front turn lamp 11R is configured with a built-in front irradiation lamp 12R and a side irradiation lamp 13R. Front turn lamp 11R mainly irradiates an amber-color flashing light as a turn indicator to the area in front of the right side of the own vehicle and the area diagonally forward to the right side of the own vehicle. Front irradiation lamp 12R irradiates a flashing light to the area in front (front forward) of the own vehicle. Side irradiation lamp 13R irradiates a flashing light to the area diagonally forward to the right side of the own vehicle.

Here, side irradiation lamps 13L, 13R may be configured separately from front 11L, turn lamps 11R respectively, without being built into front turn lamps 11L, 11R. Further, front irradiation lamp 12L and side irradiation lamp 13L may be configured by combining separate light sources and light distribution control lenses, or may be configured by combining separate light sources and light distribution control lenses integrally formed therewith. The same applies to front irradiation lamp 12R and side irradiation lamp 13R.

Each front turn lamp 11L, 11R operates according to the state of the turn signal lever 2 operated by the driver. For example, when turn signal lever 2 is in a state indicating a left turn, front irradiation lamp 12L and side irradiation lamp 13L of front turn lamp 11L of left side headlight 1L each emits a flashing light. Further, when turn signal lever 2 is in a state indicating a right turn, front irradiation lamp 12R and side irradiation lamp 13R of front turn lamp 11R of right side headlight 1R each emits a flashing light.

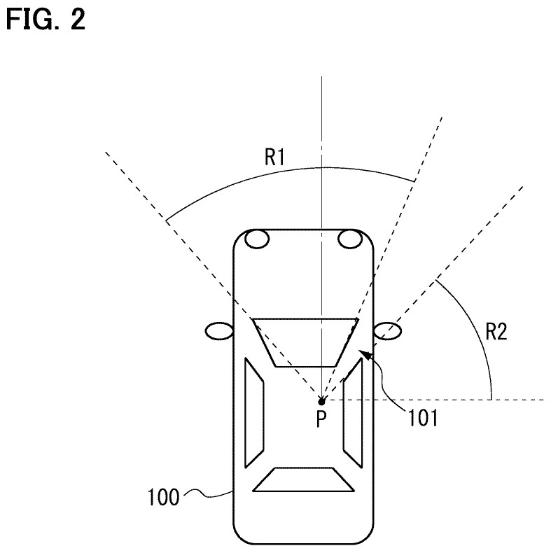

FIG. 2 is a diagram for explaining the field of view of the driver of the own vehicle. FIG. 2 shows a schematic plane view of own vehicle 100 as seen from above. Here, it is assumed that the driver's seat of own vehicle 100 is located on the right side, and the driver's viewpoint is denoted as “P”. The angle of view of area R1 visible from the front windshield of own vehicle 100 is within the range of 70° on the left side to 25° on the right side, for example. Further, the angle of view of area R2 visible from the right side window, which is behind a pillar 101 of own vehicle 100 is within the range of 30° on the right side to 90° on the right side, for example. Furthermore, the legal light distribution range (front turn light distribution standard range) is in the range of 80° on the left side to 45° on the right side or in the range of 45° on the left side to 80° on the right side, and in the range of 15° on the upper side to 15° on the lower side.

FIG. 3 is a diagram for explaining an example of an irradiation area of light emitted by the vehicle headlight of the present embodiment. FIG. 3 shows a schematic plane view similar to that of FIG. 2 described above. Each vehicle headlight 1L, 1R is disposed on the left and right sides of the front of own vehicle 100. Further, a reference line c shown by a dashed line in the figure is the fore-and-aft directional axis of own vehicle 100, which passes through the center of own vehicle 100 in the width direction and extends in a fore-and-aft direction. Further, a reference line c1 is an axis that is parallel to reference line c and extends in the fore-and-aft direction through a predetermined position of left side headlight 1L (for example, approximately the center position in the left-right direction of left side headlight 1L). And a reference line c2 is an axis that is parallel to reference line c and extends in the fore-and-aft direction through a predetermined position of right side headlight 1R (for example, approximately the center position in the left-right direction of right side headlight 1R).

As shown in the figure, a lamp 10L of left side headlight 1L irradiates a low beam LB in front of own vehicle 100. Further, front irradiation lamp 12L of front turn lamp 11L irradiates a flashing light Ta. Flashing light Ta is mainly irradiated in front of own vehicle 100. In the example shown in the figure, the irradiation area of flashing light Ta overlaps with the irradiation area of low beam LB. Here, although not shown in the figure, lamp 10L also irradiates a high beam as appropriate. Furthermore, side irradiation lamp 13L of front turn lamp 11L irradiates flashing light Tb in an area from the left diagonal front to the left side of own vehicle 100. Here, although not shown in the figure, right side headlight 1R also irradiates a similar low beam, high beam, and a flashing light. For example, a low beam or the like having a shape that is approximately symmetrical with respect to reference line c is emitted.

In the present embodiment, the angle of view of low beam LB from lamp 10L is in the range of 35° on the left side to 35° on the right side with respect to an angle based on reference line c1. The boundary that determines the angle of view of low beam LB here corresponds to the boundary between the area where the luminous intensity of low beam LB is 500 cd or more and the area where it is less than 500 cd, for example. In FIG. 3, the range of low beam LB is shown by representing this boundary with a solid line. Here, although not shown in the figure, the angle of view of the low beam from lamp 10R is similar and has a range defined with respect to an angle based on reference line c2.

The angle of view of flashing light Ta from front irradiation lamp 12L of front turn lamp 11L is included in the angle of view of low beam LB (in the range of 35° on the left side to 35° on the right side). The boundary that determines the angle of view of flashing light Ta here corresponds to the boundary between the area where the luminous intensity of flashing light Ta is 100 cd or more and the area where the luminous intensity is less than 100 cd, for example. In FIG. 3, the range of flashing light Ta is shown by showing this boundary with a dotted line. Here, although not shown in the figure, the same applies to the angle of view of the flashing light of front turn signal lamp 11R.

The angle of view of flashing light Tb from side irradiation lamp 13L of front turn lamp 11L is preferably in the range of 70° on the left side to 35° on the left side and in the range of 15° on the upper side to 15° on the lower side with respect to an angle based on reference line c1, and it is more preferable that the angle of view is in the range of 70° on the left side to 35° on the left side and in the range of 15° on the upper side to 0° (horizontal position). The horizontal position here refers to a horizontal position based on the position where left side headlight 1L is installed (the same applies hereinafter). The boundary that determines the angle of view of flashing light Tb corresponds to the boundary between the area where the luminous intensity of flashing light Tb is equal to or greater than a predetermined value and the area where the luminous intensity is less than the predetermined value. Further, it is preferable that flashing light Tb has a high luminous intensity (for example, 100 cd or more) within at least a part of the angle of view, and it is more preferable that it has a high luminous intensity in the entire area (for example, 100 cd or more).

Further, although not shown, the angle of view of the flashing light from side irradiation lamp 13R of front turn lamp 11R is preferably in the range of 80° on the right side to 30° on the right side and in the range of 15° on the upper side to 15° on the lower side with respect to an angle based on reference line c2, and it is more preferable that the angle of view of the flashing light is in the range of 80° on the right side to 30° on the right side and in the range of 15° on the upper side to 0° on the lower side. The boundary that determines the angle of view of the flashing light corresponds to the boundary between the area where the luminous intensity of the flashing light is equal to or greater than a predetermined value and the area where the luminous intensity is less than the predetermined value. It is preferable that this flashing light has a high luminous intensity within at least a part of the angle of view (for example, 100 cd or more), and it is more preferable that it has a high luminous intensity in the entire area (for example, 100 cd or more).

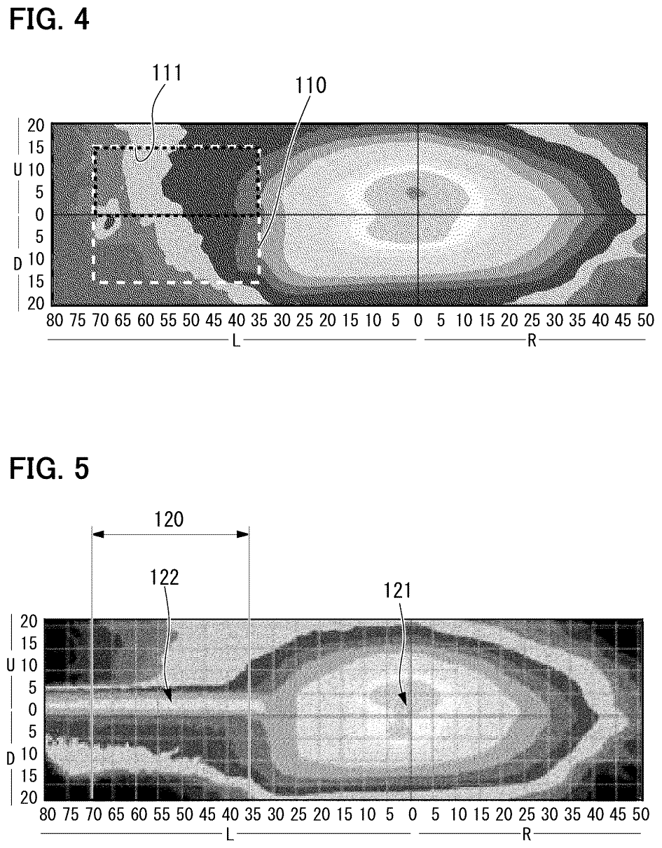

FIG. 4 is a diagram for explaining the range of flashing light Tb emitted from side irradiation lamp 13L of front turn lamp 11L. FIG. 4 shows the luminous intensity distribution on a virtual screen arranged along the vertical direction at a predetermined position in front of the own vehicle (in this example, 10 m ahead of the own vehicle). The rectangular area 110 shown by a white dotted line in the figure shows the irradiation range of flashing light Tb set in the range of 70° on the left side to 35° on the left side and in the range of 15° on the upper side to 15° on the lower side with respect to an angle based on reference line c1. The position of reference line c1 is 0° in the left-right direction.

As shown in the figure, the irradiation range of flashing light Tb is set to the left of the boundary 35° to the left where the luminous intensity of low beam LB is less than 500 cd. This area is also the area in which luminous intensity of flashing light Ta becomes less than 100 cd. This area is also the area visible to the driver of the own vehicle (refer to FIG. 2). Therefore, by irradiating the area with flashing light Tb from side irradiation lamp 13L, the amount of light on the left side of the own vehicle increases, and as a result, it is possible for the driver to more easily feel that the front turn lamp is turned on. Further, by making it easier to feel that the front turn lamp is turned on, it is possible to prevent the driver from forgetting to turn off the turn lamp. Here, although not shown in the figure, the same effect can be obtained with the flashing light from side irradiation lamp 13R.

The rectangular area 111 shown by a black dotted line in the figure indicates the irradiation range of flashing light Tb which is set in the range of 70° on the left side to 35° on the left side and in the range of 15° on the upper side to 0° (horizontal position) with respect to an angle based on reference line c1. Even when the vertical range is narrowed to the upper side of 0°, since the amount of light in low beam LB area with low luminous intensity can be increased, the same advantageous effect as above can be obtained. That is, it becomes easier for the driver to feel that the front turn lamp is turned on, and it is possible to prevent the driver from forgetting to turn off the front turn lamp. Here, although not shown in the figure, the same effect can be obtained with the flashing light from side irradiation lamp 13R.

As a further preferred embodiment, the angle of view of flashing light Tb from side irradiation lamp 13L can be in the range of 70° on the left side to 35° on the left side and in the range of 5° on the upper side to 0° with respect to an angle based on reference line c1. Similarly, the angle of view of the flashing light from side irradiation lamp 13R can be in the range of 80° on the right side to 30° on the right side and in the range of 5° on the upper side to 0° with respect to an angle based on reference line c2. As a result, when a pedestrian is present in the irradiation range of the flashing light, glare to the pedestrian can be reduced.

FIG. 5 is a diagram for explaining an example of irradiation of flashing lights Ta, Tb by front turn lamp 11L. FIG. 5 also shows the luminous intensity distribution on a virtual screen arranged along the vertical direction at a predetermined position in front of the own vehicle (in this example, 10 m ahead of the own vehicle). In the figure, the line extending left and right at the 0° position in the up-down direction (vertical direction) corresponds the horizontal line, and the line extending up and down at the 0° position in the left-right direction (horizontal direction) corresponds to the vertical line.

As illustrated in the figure, as a light distribution pattern on a virtual screen, within the front turn light distribution standard range, the light emitted by flashing lights Ta and Tb has a first luminous intensity peak 121 near the center in which the horizontal line and vertical line intersect. In the illustrated example, first luminous intensity peak 121 is the area with the highest luminous intensity within an angular range of 35° or less to the left and right side, and is the area in which light of 600 cd or more is irradiated, for example.

Further, as a light distribution pattern on a virtual screen, within the front turn light distribution standard range, the light emitted by flashing lights Ta and Tb has a second luminous intensity peak 122 at an angle position 120 away from the front of the vehicle to the side of the vehicle. In the illustrated example, second luminous intensity peak 122 is the area with the highest luminous intensity within an angle range of 35° to 70° on the left side with respect to an angle based on reference line c1, and is an area in which light of 100 cd or more is irradiated, for example. This second luminous intensity peak 122 can also be said to be a continuous luminous intensity band formed so that light of 100 cd or more is irradiated. Second luminous intensity peak 122 is included within the irradiation range of flashing light Tb from side irradiation lamp 13L of front turn lamp 11L. The preferable conditions for this irradiation range are as described above.

Although not shown in the figure, flashing lights Ta, Tb from front turn signal lamp 11R also has a first luminous intensity peak and a second luminous intensity peak similar to the irradiation example shown in FIG. 5.

According to the first embodiment described above, it makes it easier for the driver to feel that the front turn lamp is turned on.

### Second Embodiment

When the operation of side irradiation lamps 13L, 13R of front turn lamps 11L, 11R is linked to front irradiation lamps 12L, 12R respectively, the operation of side irradiation lamps 13L, 13R may be controlled in consideration of the environment around the own vehicle. Here, in the following, the configuration that differs from the first embodiment will mainly be described, and the configuration that does not differ will be omitted.

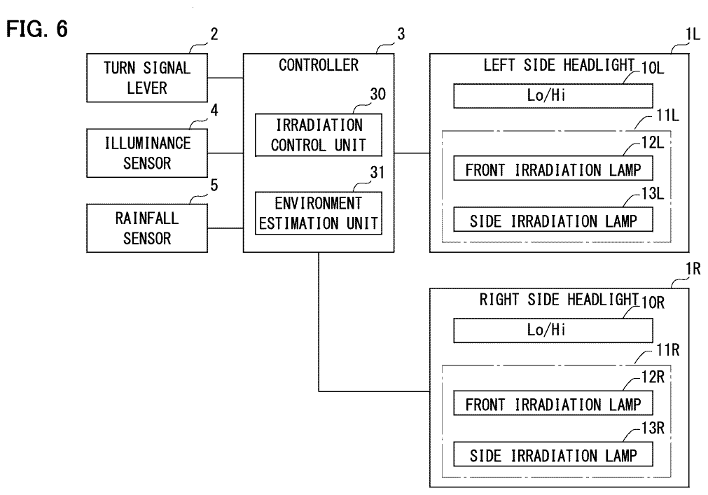

FIG. 6 is a block diagram for explaining the configuration of a vehicle headlight according to the second embodiment. The vehicle headlight of the second embodiment is configured to include a left side headlight 1L, a right side headlight 1R, a turn signal lever 2, a controller 3, an illuminance sensor 4, and a rainfall sensor 5. In the second embodiment, front irradiation lamp 12L and side irradiation lamp 13L are separate. Front turn lamp 11L is configured to include front irradiation lamp 12L and side irradiation lamp 13L. Similarly, front irradiation 12R and side lamp irradiation lamp 13R are separate. Front turn lamp 11R is configured to include front irradiation lamp 12R and side irradiation lamp 13R. Here, note that each of them may be integrally configured as in the first embodiment.

Controller 3 is realized by executing a predetermined operating program in a computer having a processor and memory, for example. This controller 3 has, as functional blocks, an irradiation control unit (irradiation control function) 30 and an environment estimation unit (environment estimation function) 31.

Irradiation control unit 30 controls light irradiation state of left side headlight 1L and right side headlight 1R based on the operating state of a lamp switch (not shown) and turn signal lever 2 and the estimation result from environment estimation unit 31. Specifically, irradiation control unit 30 controls the low beam and high beam irradiation state of lamps 10L and 10R based on the operating state of the lamp switch. Further, irradiation control unit 30 controls the irradiation state of front turn lamps 11L and 11R based on the operating state of turn signal lever 2. Furthermore, irradiation control unit 30 controls the irradiation state of each side irradiation lamp 13L and 13R based on the operating state of turn signal lever 2 and the estimation result from environment estimation unit 31.

Environment estimation unit 31 estimates whether the illuminance around the own vehicle is equivalent to nighttime, based on the illuminance around the own vehicle detected by illuminance sensor 4. Further, environment estimation unit 31 estimates whether the amount of rainfall around the own vehicle is equivalent to rainy weather based on the amount of rainfall around the own vehicle detected by rainfall sensor 5. Each estimation result is passed from environment estimation unit 31 to irradiation control unit 30.

Next, the control content of left side headlight 1L and right side headlight 1R by controller 3 will be described.

For example, when irradiation control unit 30 controls lamps 10L, 10R to emit low beam or high beam based on the operating state of the lamp switch, it can activate side irradiation lamps 13L, 13R in conjunction with front irradiation lamps 12L, 12R.

Further, when the estimation result from environment estimation unit 31 indicates that it is nighttime, irradiation control unit 30 can activate side irradiation lamps 13L, 13R in conjunction with front turn signals 11L, 11R.

Further, when the estimation result from environment estimation unit 31 indicates that it is raining, irradiation control unit 30 can activate side irradiation lamps 13L, 13R in conjunction with front irradiation lamps 12L, 12R.

Furthermore, when it is nighttime and raining based on the estimation result from environment estimation unit 31, irradiation control unit 30 can activate side irradiation lamps 13L, 13R in conjunction with front irradiation lamps 12L, 12R.

According to the second embodiment described above as well, it makes it easier for the driver to feel that the front turn lamps are turned on. In particular, by controlling the operation of side irradiation lamps 13L and 13R according to the surrounding environment of the own vehicle, it is possible to selectively activate side irradiation lamps 13L and 13R toward a situation where it is more necessary.

Here, note that the present disclosure is not limited to the content of the above described embodiments, and various modifications can be made within the scope of the gist of the present disclosure. For example, in the above-described embodiments, it is assumed that the driver's seat of the own vehicle is located on the right side, that is, the left side is defined as the “first side” and the right side is defined as the “second side”, but the left and right sides may be reversed. That is, the driver's seat may be located on the left side, and the right side may correspond to the “first side” and the left side may correspond to the “second side”. In this case, the irradiation ranges of side irradiation lamps 13L and 13R described above may be reversed in the left and right directions.

Further, the high beam in each of the above-descried embodiments may be a selective high beam in which a dimming range is provided according to the position of other vehicles, etc. in front of the own vehicle. Further, flashing cycle of the flashing lights from side irradiation lamps 13L, 13R and front irradiation lamps 12L, 12R may be different from each other or may be the same.

In addition, in each of the above-descried embodiments, the angle of view of the flashing light from side irradiation lamp 13L and the angle of view of the flashing light from side asymmetric irradiation lamp 13R are in the left-right direction, but they may be symmetric. As an example, the angle of view of the flashing light from side irradiation lamp 13L may be in the range of 80° on the left side to 30° on the left side with respect to an angle based on reference line c1, and the angle of view of the flashing light from side irradiation lamp 13R can be in the range of 80° on the right side to 30° on the right side with respect to an angle based on reference line c2. In this case, the vertical direction can be in the range of 15° on the upper side to 15° on the lower side as described above, and it is preferable to set it in the range of 15° on the upper side to 0°, and it is more preferable to set it in the range of 5° on the upper side to 0°.

Further, in the second embodiment described above, rain was detected using a rainfall sensor, but rain may also be detected based on the operating state of the wiper switch of the own vehicle, or rain may be detected based on weather information that can be obtained from outside via wireless communication.

Furthermore, in each of the above-described embodiments, front turn lamps 11L, 11R are configured as separate lamps that irradiate light in the direction in front of the vehicle and lamps that irradiate light to the sides of the vehicle, but the lamps may be configured as one unit rather than being separate.

### DESCRIPTION OF SYMBOLS

1L: Left side headlight
1R: Right side headlight
2: Turn signal lever
3: Controller
4: Illuminance sensor
5: Rainfall sensor
10L, 10R: Lamp (Lo/Hi)
11L, 11R: Front turn lamp
12L, 12R: Front irradiation lamp
13L, 13R: Side irradiation lamp

What is claimed is:

1. A front turn lamp arranged adjacent to each of a pair of headlights or integrally arranged with the pair of headlights at the front of a vehicle, characterized in that,
as a light distribution pattern on a virtual screen of the front turn lamp, within a front turn light distribution standard range, a light emitted by the front turn lamp has a first luminous intensity peak near where a horizontal line intersects with a vertical line, and a second luminous intensity peak at an angle position away from the front of the vehicle to the side thereof.

2. The front turn lamp according to claim 1 comprising:
a first front turn lamp that is arranged on a first side, which is one of the left and right sides of the vehicle and is not the side where the driver's seat is located, and is configured to be able to irradiate a first flashing light onto an area including a first range extending diagonally forward to the side of the first side; and
a second front turn lamp that is arranged on a second side opposite the first side, and is configured to be able to irradiate a second flashing light onto an area including a second range extending diagonally forward to the side of the second side;
wherein the first range is a range on a virtual screen of the first front turn lamp, and is set within a range of 80° to 30° on the first side and within a range of 15° on the upper side to 15° on the lower side in the vertical direction based on an axis that is parallel to fore-and-aft direction of the vehicle and passes through a predetermined position of the first front turn lamp, and the second luminous intensity peak of the first front turn lamp is within the first range, and
wherein the second range is a range on a virtual screen of the second front turn lamp, and is set within a range of 80° to 30° on the second side and within a range of 15° on the upper side to 15° on the lower side in the vertical direction based on an axis that is parallel to the fore-and-aft direction of the vehicle and passes through a predetermined position of the second front turn lamp, and the second luminous intensity peak of the second front turn lamp is within the second range.

3. A front turn lamp arranged adjacent to each of a pair of headlights or integrally arranged with the pair of headlights at the front of a vehicle, the front turn lamp comprising:
a first front turn lamp that is arranged on a first side, which is one of the left and right sides of the vehicle and is not the side where a driver's seat is located, and is configured to be able to irradiate a first flashing light onto an area including a first range extending diagonally forward to the side of the first side; and
a second front turn lamp that is arranged on a second side opposite the first side, and is configured to be able to irradiate a second flashing light onto an area including a second range extending diagonally forward to the side of the second side;
wherein the first range is a range on a virtual screen of the first front turn lamp, and is set within a range of 80° to 30° on the first side based on an axis that is parallel to fore-and-aft direction of the vehicle and passes through a predetermined position of the first front turn lamp,
wherein, in the first range, a continuous luminous intensity band of 100 cd or more is formed when the first flashing light is emitted by the first front turn lamp;
wherein the second range is a range on a virtual screen of the second front turn lamp, and is set within a range of 80° to 30° on the second side based on an axis that is parallel to fore-and-aft direction of the vehicle and passes through a predetermined position of the second front turn lamp; and
wherein, in the second continuous luminous intensity band of 100 cd or more is formed when the second flashing light is emitted by the second front turn lamp.

4. The front turn lamp according to claim 2,
wherein the first range is set within a range of 70° to 35°.

5. The front turn lamp according to claim 2,
wherein each of the first range and the second range is set within a range of 15° on the upper side to 0° in the vertical direction.

6. The front turn lamp according to claim 2,
wherein each of the first range and the second range is set within a range of 5° on the upper side to 0° in the vertical direction.

7. The front turn lamp according to claim 2,
wherein each of the first flashing light and the second flashing light is an amber-color light.

8. The front turn lamp according to claim 2,
wherein the first flashing light has a luminous intensity of 100 cd or more within at least a part of the second range, and
wherein the second flashing light has a luminous intensity of 100 cd or more within at least a part of the second range.

9. A vehicle headlight comprising:
the front turn lamp according to claim 1;
a controller connected to the front turn lamp; and
a rainfall sensor connected to the controller,
wherein the controller activates the front turn lamp when it is estimated that it is raining around the vehicle based on a detection result of the rainfall sensor.

10. A vehicle headlight comprising:
the front turn lamp according to claim 1;
a controller connected to the front turn lamp; and
an illuminance sensor connected to the controller,
wherein the controller activates the front turn lamp when it is estimated that it is nighttime around the vehicle based on a detection result of the illuminance sensor.
